(19) United States
(12) Patent Application Publication
(10) Pub. No.: US 2008/0308121 A1
(43) Pub. Date: Dec. 18, 2008

(54) Portable Die Cleaning Apparatus and Method Thereof

(75) Inventors: Hae Ryong Lee, Seongnam-si (KR); Keun Ho Lee, Seongnam-si (KR); Duk Jae Kim, Seoul (KR); Jung Keun Oh, Incheon (KR); Do Hyun Kim, Gwangju (KR)

Correspondence Address: SEED INTELLECTUAL PROPERTY LAW GROUP PLLC, 701 FIFTH AVE, SUITE 5400, SEATTLE, WA, 98104, US

(73) Assignee: PSM INC., Seongnam-si (KR)

(21) Appl. No.: 12/064,015

(22) PCT Filed: Sep. 5, 2006
(86) PCT No.: PCT/KR2006/003505

§ 371 Date: Aug. 18, 2008

(30) Foreign Application Priority Data
Sep. 6, 2005 (KR) 10-2005-0082569

(51) Int. Cl. B08B 7/00

(52) U.S. Cl. 134/1.1; 134/58 R

(57) ABSTRACT

A portable die cleaning apparatus and method are provided The apparatus is capable of performing a plasma cleaning process for a surface of a die using plasma discharge generated in a reaction chamber that is defined on the die, without separating the die. The portable die cleaning apparatus includes a frame with an open lower face to define a reaction chamber facing the surface of the die between the surface of the die and the frame itself when the frame is seated on the die and an active electrode that is placed at a position opposite to the die in a state where the die is electrically grounded, and receives electric power from an external power supply to generate plasma in the reaction chamber.

### BACKGROUND

1. Technical Field

The present invention relates to a portable die cleaning apparatus and a die cleaning method using the same, and more particularly, to a portable die cleaning apparatus and a die cleaning method using the same, wherein a die for use in molding semiconductors, electronic components or the like out of a resin can be cleaned through a plasma cleaning process in a plasma discharge manner without separating the die.

2. Description of the Related Art

In processes of fabricating electronic components, especially semiconductors, a process of performing resin molding for a substrate such as a lead frame or a ball grid array (BGA) with semiconductor chips mounted thereon is carried out in a state where the substrate is supported by a die. Such a molding process is performed by filling a plurality of cavities formed in the die with a resin. However, since resin remnants are attached or adhere to the cavities due to repeated molding processes, they become one of causes of obstruction of the molding process.

Accordingly, it is necessary to periodically clean a die, especially inner surfaces of cavities formed in the die. Recently, the cleaning of the die described above has been performed in such a manner that an operator manually removes foreign substances (especially resin remnants) in the cavities of the die by using chemicals or the like. However, the manual cleaning of the die is led to a large waste of manpower and time and has limitations on complete removal of the resin remnants. Furthermore, since the die is at a high temperature during the molding, the operator may be exposed to a danger when he/she manually cleans the die. There is also a problem in that the chemicals used through the cleaning process may cause environmental pollution.

In order to solve these problems, it has been contemplated by the inventor that a die is separated from a molding machine and the separated die is loaded into a furnace type plasma apparatus so that plasma cleaning can be made for a surface of the die. In this case, however, there are problems in that separating and remounting the die requires a waste of manpower and time and the temperature of the die should be considered upon separation of the die. Further, a conventional technique has been proposed in which a dielectric is formed on a discharge electrode, holes for supplying a gas therethrough are formed in the dielectric, the gas is supplied through the holes in a state where the discharge electrode is placed on a cavity of a die, and plasma is generated between the discharge electrode and a ground electrode connected to the die. This technique is disclosed in Japan Patent Laid-Open Publication No. 2000-167853. However, such a technique also has problems in that the practicability of the technique is considerably lowered since the holes should be formed in the dielectric to correspond to respective cavities, and the utility thereof is greatly degraded since the plasma generating space is too small. In addition, there are limitations on plasma treatment of dies with different specifications.

### BRIEF SUMMARY

According to one embodiment, an apparatus and method capable of performing a plasma cleaning process for a surface of a die is provided, including entire surfaces of cavities in the die, without separating the die from a molding machine.

Accordingly, an object of the present invention is to provide a portable die cleaning apparatus capable of performing a plasma cleaning process for a surface of a die, including surfaces of cavities in the die, by using plasma discharge generated in a reaction chamber that is defined on the die, without separating the die.

Another object of the present invention is to provide a die cleaning method using plasma, wherein a plasma cleaning process for a surface of a die, including surfaces of cavities in the die, is performed by using plasma discharge generated in a reaction chamber that is defined on the die, without separating the die.

In one embodiment, the present invention provides a portable die cleaning apparatus for cleaning a surface of a die using plasma discharge. The portable die cleaning apparatus includes a frame with an open lower face to define a reaction chamber facing the surface of the die between the surface of the die and the frame itself when the frame is seated on the die, and an active electrode that is placed at a position opposite to the die in a state where the die is electrically grounded, and receives electric power from an external power supply to generate plasma in the reaction chamber. Therefore, the frame is seated on the die so that the reaction chamber can be defined to face the surface of the die, and plasma discharge generated in the reaction chamber can be preferably used to perform cleaning for the surface of the die, including surfaces of cavities in the die.

According to one embodiment, the frame may include a box-shaped body frame with the active electrode installed therein, and an attach frame that is in the form of a picture frame and has an upper face in close contact with the body frame and a lower face in close contact with the surface of the die. This configuration allows dies with different specifications to be cleaned by exchanging the attach frame in the die cleaning apparatus of the present invention.

The attach frame may have seal packing at a portion thereof that is brought into contact with the surface of the die. Seal packing may be provided at a portion where the attach frame and the body frame are brought into contact with each other. The sealing packing enables the reaction chamber to be sealed more completely, thereby contributing to formation of the plasma.

The apparatus may further include a vacuum pump for regulating pressure within the reaction chamber.

According to one embodiment, a die cleaning method using a portable die cleaning apparatus for cleaning a surface of a die includes a chamber defining step of defining a reaction chamber on the surface of the die by positioning the portable die cleaning apparatus on the surface of the die, and a cleaning step of generating plasma in the reaction chamber and cleaning the surface of the die using the plasma.

According to embodiments the present invention, in a case where a die for use in molding, for example, semiconductor chips or the like, is cleaned, foreign substances such as resin remnants attached on cavities of the die can be removed using plasma without separating the die from a molding machine.

Accordingly, a great deal of inconvenience caused in separating and remounting the die from and to the molding machine and a resulting great waste in view of economics can be reduced, foreign substances on the surface of the die can be removed more clearly as compared with a manual cleaning process using chemicals, and environmental pollution due to the chemicals can be suppressed or reduced.

### BRIEF DESCRIPTION OF THE SEVERAL VIEWS OF THE DRAWING(S)

FIG. 1 is an exploded isometric view schematically showing a portable die cleaning apparatus according to one embodiment, together with a die to be cleaned.

FIG. 2 is a sectional view showing a state where the portable die cleaning apparatus shown in FIG. 1 is seated on the die.

FIG. 3 is a schematic view illustrating a cleaning process of removing foreign substances on the die by using the portable cleaning apparatus shown in FIGS. 1 and 2.

### DETAILED DESCRIPTION

Hereinafter, a preferred embodiment will be described in detail with reference to the accompanying drawings.

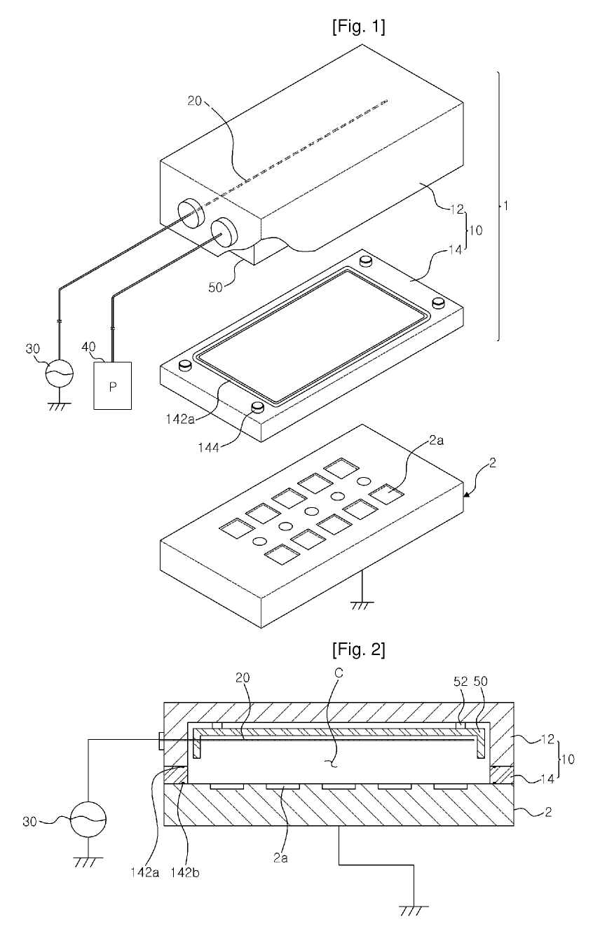

FIG. 1 is an exploded isometric view showing a die cleaning apparatus according to one embodiment, together with a die to be cleaned, and FIG. 2 is a sectional view schematically showing a state where the die cleaning apparatus shown in FIG. 1 is seated on the die.

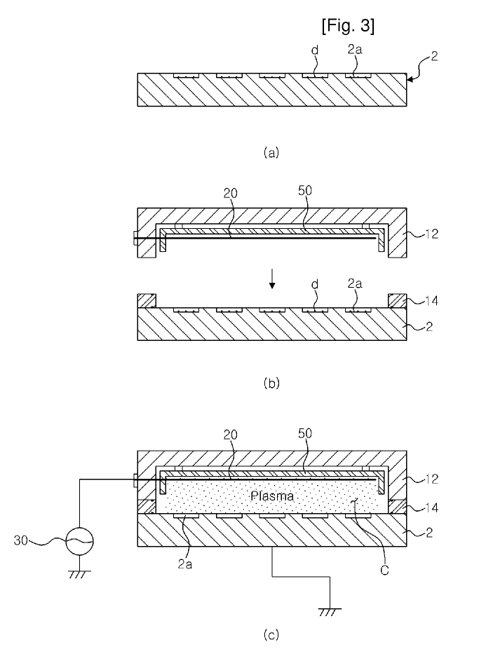

As shown in FIGS. 1 and 2, a die 2 that will be subjected to surface cleaning is a die for use in molding semiconductor chips (not shown), and has a surface formed with a plurality of cavities 2a serving as spaces to be filled with a resin during molding. Since resin remnants d (see FIG. 3) are attached mainly to inner surfaces of the cavities 2a of the die 2 when the molding of the semiconductor chips is performed, it is significantly necessary to clean the die 2, especially the surfaces of the cavities 2a of the die 2.

A die cleaning apparatus 1 according to one embodiment includes a frame 10 with an open lower face for defining a reaction chamber C (FIG. 2), and an active electrode 20 provided inside the frame 10. The active electrode 20 is connected to an external power supply 30 such as a DC power supply or an AC power supply, for example, an RF power supply, an MF power supply or the like and receives electric power with a high voltage from the external power supply 30. Since the die 2 is electrically grounded to the outside at a side thereof, it serves as a ground electrode.

Meanwhile, the frame 10 in the preferred embodiment has a box-shaped body frame 12 enabling the active electrode 20 to be installed while penetrating therethrough, and an attach frame 14 that includes a shape similar to that of a picture frame and constitutes one set together with the body frame 12. Since the attach frame 14 and the body frame 12 are separately formed as describe above, the die cleaning apparatus 1 according to embodiments of the present invention can clean dies 2 with different specifications by means of plasma cleaning while exchanging various kinds of attach frames 14.

In this embodiment, the attach frame 14 can be in the form of a substantially rectangular picture frame and has first and second seal packing 142a and 142b respectively positioned on upper and lower surfaces of the attach frame 14. The first seal packing 142a enhances airtightness between the body frame 12 and the attach frame 14, whereas the second seal packing 142b enhances airtightness between the attach frame 14 and the die 2. Additionally, the attach frame 14 has a plurality of frame-fitting insertion protrusions 144 on the upper surface thereof. The insertion protrusions 144 are fitted into frame-fitting insertion recesses (not shown) formed on a lower surface of the body frame 12, so that the body frame 12 and the attach frame 14 can be aligned with each other.

The die cleaning apparatus 1 according to one embodiment includes a vacuum pump 40 for regulating pressure within the reaction chamber C in addition to the active electrode 20 for generating plasma discharge as described above. The active electrode 20 is placed within the reaction chamber C while being connected to the external power supply 30 and penetrating through the body frame 12 and at least a portion of a box-shaped insulator 50 that is suspended from the body frame 12 by means of a certain fixing means 52. The vacuum pump 40 facilitates a low vacuum pressure condition for generating plasma. However, the vacuum pump 40 may be omitted by causing the active electrode 20 to have a dielectric so that the dielectric can implement plasma discharge under atmospheric pressure. This also falls within the scope of the present invention.

FIG. 3 is a schematic view sequentially illustrating a process of cleaning a die, especially surfaces of cavities formed on the die, using the die cleaning apparatus described above.

FIG. 3 (a) shows the die 2 with the cavity 2a to which some resin remnants d are attached. In order to remove the resin remnants d attached to the die 2, the attach frame 14 constituting a part of the die cleaning apparatus 1 is first seated on the die 2 as shown in FIG. 3 (b). Then, the body frame 12, with the active electrode 20 installed therein, is seated on the attach frame 14. In this state, the die cleaning apparatus 1 described above can perform plasma cleaning for the surface of the die 2. At this position, the die 2 is electrically grounded to the outside to define a ground electrode. When the active electrode 20 receives electric power from the external power supply 30, gas in the reaction chamber C, especially between the die 2 and the active electrode 20, collides with accelerated electrons and is activated to plasma. The activated plasma decomposes the resin remnants inside the cavity 2a of the die 2.

Although the frame for defining the reaction chamber C has been described as being divided into the body frame and the attach frame in the embodiment described above, this is merely an example. In another embodiment, only the box-shaped body frame may be used to define the reaction chamber.

Further, the die cleaning apparatus can be partially or entirely connected to a driving means such as a robot arm, a hydraulic or pneumatic actuator, or an electric actuator so that the plasma cleaning for the surface of the die can be performed in an automatically controlled manner.

Although the present invention has been described in connection with the preferred embodiment, various changes, modifications and corrections can be made within the spirit of the invention and the scope of the invention defined by the appended claims. Accordingly, the above description and the accompanying drawings should be construed as exemplifying the present invention rather than limiting the technical spirit of the invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A portable die cleaning apparatus for cleaning a surface of a die using plasma discharge, comprising:
a frame with an open lower face to define a reaction chamber facing the surface of the die between the surface of the die and the frame when the frame is seated on the die; and
an active electrode positioned in a location facing the die; and;
an electrical ground coupled to the die so that the die is electrically grounded;
the active electrode being configured to receive electric power from an external power supply to generate plasma in the reaction chamber.

2. The apparatus as claimed in claim 1, wherein the frame includes:
a box-shaped body frame with the active electrode installed therein at a position opposite to the die; and
an attach frame in a form of a picture frame, the attach frame having an upper face coupled to the body frame and a lower face coupled to the surface of the die.

3. The apparatus as claimed in claim 2 wherein the attach frame has seal packing at a portion thereof that is brought into contact with the surface of the die.

4. The apparatus as claimed in claim 2 wherein seal packing is provided at a portion where the attach frame and the body frame are brought into contact with each other.

5. The apparatus as claimed in claim 1, further comprising:
a vacuum pump to regulate pressure within the reaction chamber.

6. The apparatus as claimed in claim 1 wherein the active electrode has a dielectric for generating plasma discharge under atmospheric pressure.

7. The apparatus as claimed in claim 1 wherein the die is provided with a plurality of cavities for molding semiconductors out of resin.

8. A die cleaning method for cleaning a surface of a die using a portable die cleaning apparatus, comprising the steps of:
defining a reaction chamber on the surface of the die by positioning the portable die cleaning apparatus on the surface of the die;
generating plasma in the reaction chamber; and
cleaning the surface of the die using the plasma.

9. The method as claimed in claim 8 wherein the chamber defining step includes seating an attach frame on the die; and
seating a body frame, with an active electrode installed therein, on the attach frame.

10. The method as claimed in claim 8 wherein, in the cleaning step, the die is electrically grounded, and electric power for plasma discharge is applied to the active electrode placed within the reaction chamber.
